(19) United States
(12) Patent Application Publication
(10) Pub. No.: US 2010/0237084 A1
(43) Pub. Date: Sep. 23, 2010

(54) Rolling Transport Container

(76) Inventor: Jerry Russell Freed, Tampa, FL (US)

Correspondence Address: Law Office of Stacy Matulis, 9806 Gretna Green Drive, Tampa, FL, 33626, US

(21) Appl. No.: 12/406,280

(22) Filed: Mar. 18, 2009

(51) Int. Cl. B65D 25/00; B62B 1/00

(52) U.S. Cl. 220/694; 280/47.26; 280/47.315

(57) ABSTRACT

A rolling container for transporting items comprising: a storage compartment having an opening and one or more rolling mechanisms; said opening large enough to be lowered over the item to be transported; said storage compartment large enough to contain the item to be transported; said rolling mechanisms attached to the exterior of the storage compartment at a location adjacent to said opening such that after the item to be transported is enclosed within said storage compartment, the container can be shifted approximately ninety degrees from a position of resting on the item to be transported (opening down) to a position of resting on said rolling mechanisms (rolling mechanisms down). A method for loading an item to be transported into a rolling transport container comprising the following steps: lowering the opening of the container over the item to be transported until the item is substantially contained within the storage compartment; shifting the loaded container approximately ninety degrees until the item to be transported is resting on the rolling mechanisms.

### FIELD OF THE INVENTION

This invention relates to rolling transport containers and methods for using rolling transport containers.

### BACKGROUND OF THE INVENTION

Rolling transport containers are useful in allowing users to transport items inside a protective case or covering, without having to bear the weight of the items. There are a variety of rolling transport containers in the prior art, including rolling camera cases, rolling brief cases, rolling luggage, rolling golf bags, and the like.

An example of a known design for rolling luggage is U.S. Pat. No. 5,048,649 to Carpenter et al. An example of a more recent disclosure is U.S. Patent Application 20070256607 by Friedman, which discloses a rolling case for a massage table. This design comprises a durable storage compartment affixed to a base with a telescopic handle that extends up from the top of the case, and rollers at the bottom. The rollers are situated at the back of the base of the case, and there are legs affixed to the front of the base, so that the case can be tilted onto the wheels for transport, and rested on the legs when the case is stationary. Friedman also discloses lift handles and shoulder straps, as well as external accessory pockets.

### SUMMARY OF THE INVENTION

As discussed above, it is known to mount wheels on the bottom of a transport container and attach a handle to work in connection with the wheels to pull the container. However, the known inventions are only useful so long as the item to be transported can be placed into the opening of the transport container by the user. The known inventions are not useful if the item to be transported is too large or heavy to easily lift and place into the container. It would be advantageous to provide a rolling transport container that can be lowered over the top of a large or heavy item to load the item into the container, so that the item to be loaded need not be lifted or otherwise placed into the container.

Thus, the inventor herein has designed a rolling container and method for use that allows the container to be lowered over an item that is too heavy or large to be otherwise placed in the container. Once the item is fully enclosed within the container, the container with contents is then shifted onto rolling mechanisms for transport.

It is therefore an object of the invention to provide a rolling container that can be lowered over the item to be transported.

It is a further object to provide a rolling container that is collapsible for ease of use and better storage when not in use.

It is a further object to provide a rolling container with an opening situated adjacent to the rolling mechanisms such that the container can be readily shifted onto the rolling mechanisms after the rolling container has been lowered over the item to be transported.

It is a further object to provide a rolling container with strategically placed handles to assist in lowering the container over items, to tow the container after it is shifted onto its wheels, and to lift the container when necessary.

It is a further object to provide a rolling container with skid bars and external pockets.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims.

FIG. 1 is a perspective view of one embodiment of a rolling transport container according to the present invention, shown with the opening facing down and a zip down flap closing mechanism in the open position,

FIG. 2 depicts a method of using a rolling transport container according to the present invention to transport a large pro audio speaker. FIG. 2 depicts an embodiment the invention in a variety of perspectives and views in Steps 2 through 6.

### DETAILED DESCRIPTION OF THE INVENTION

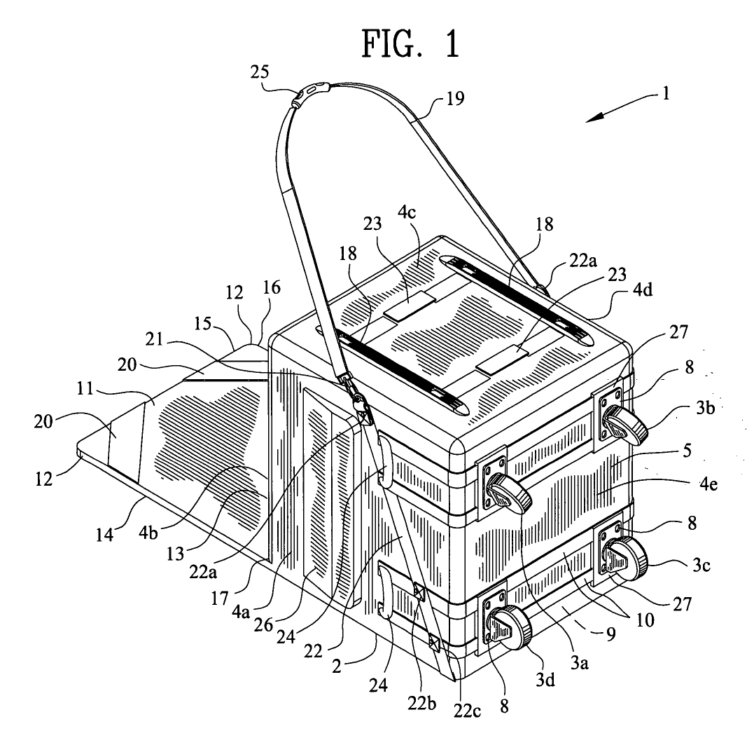

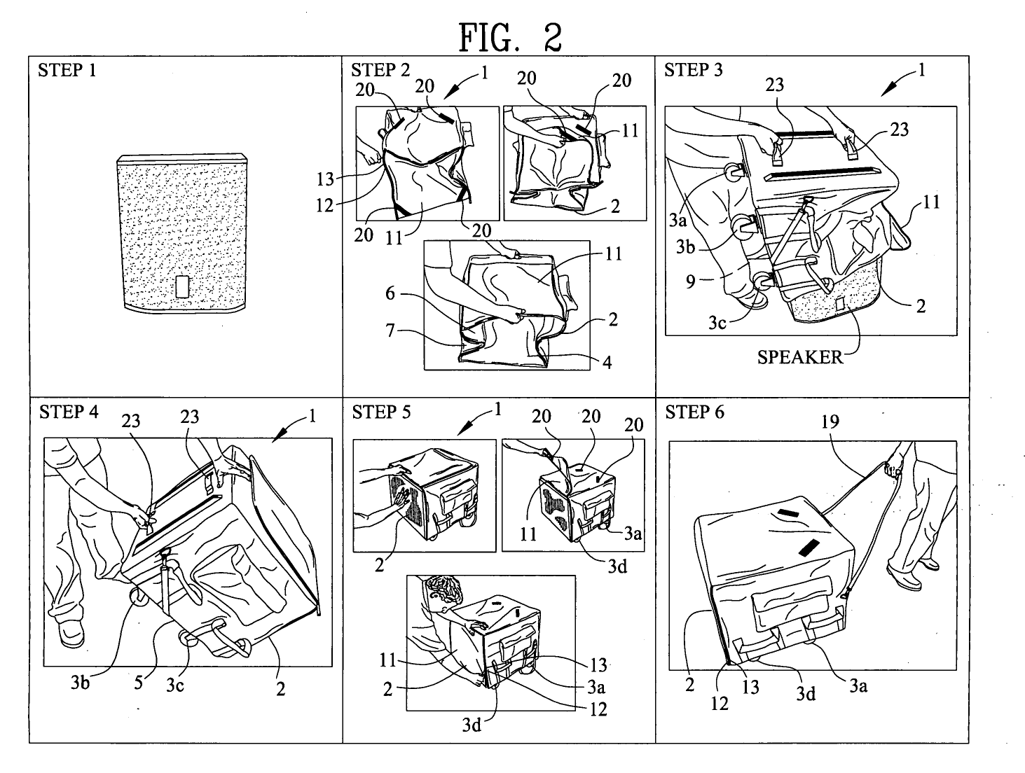

Referring to FIG. 1 and FIG. 2, rolling transport containers and methods for use according to embodiments and methods of the present invention are now described.

FIG. 1 depicts an embodiment of the rolling transport container 1 with the opening 2 facing down and thus not visible. In FIG. 1, the container appears square in shape, which may be preferred for square shaped items. This shape is also sometimes preferred as a useful storage container shape. However, it should be understood that the invention is not limited to any particular shape. FIG.1 also depicts the container in what appears to be a rigid form, but it is to be understood that the container need not be rigid and in some preferred embodiments would be collapsible for easier handling, and for easier storage when not in use. The rigid appearance of FIG. 1 allows for all of the features to be readily viewed but is not intended to limit the scope of the invention to a rigidly shaped container.

Thus, the rolling transport container 1 comprises an opening 2 and one or more rolling mechanisms 3a-3d (collectively 3). There is a storage compartment 4 defined by the various sides (4a-4e) of the container. (See FIG. 1). Because the opening 2 of the container depicted in FIG. 1 is facing down and thus not visible, the interior storage compartment 4 is likewise not visible. But the storage compartment 4 of an embodiment is visible in FIG. 2, Step 2. (See bottom figure of STEP 2).

The opening 2 is large enough to be lowered over the item to be transported. The storage compartment 4 is of the appropriate size and shape to accommodate the item to be transported, and thus may vary widely among the various embodiments of the present invention. The rolling mechanisms 3 are attached to the exterior of the container 1 in relation to the opening 2 such that after the opening has been lowered over the item to be transported and the item is within the storage compartment 4, the container can be shifted onto the rolling mechanisms 3 for transport. Thus, in the disclosed embodiments, the rolling mechanisms 3 are not placed substantially opposite the opening 2, as is typical in the prior art. Rather, the rolling mechanisms 3 are located adjacent to the opening 2 to allow the container 1 to be readily shifted onto the rolling mechanisms 3 once the item is inside the storage compartment 4.

In the disclosed embodiments, the placement of the rolling mechanisms 3 in relation to the opening 2 is such that an approximately 90 degree shift of the container 1 will move the container 1 from resting with the opening 2 facing down, to resting on the rolling mechanisms 3 (i.e., rolling mechanisms 3 down). At the same time, this approximately 90 degree shift of the container 1 also results in the item to be transported being relocated from resting on the ground or floor surface, to resting on the interior portion of the storage compartment 4 that is now resting on the rolling mechanisms 3, i.e., the interior of side 4e in FIG. 1.

For a square shaped container, any location adjacent to the opening 2 can be selected for the placement of the rolling mechanisms 3, so long as there are no other features in the way (such as pockets, handles, and the like) that would interfere with shifting the container 1 from resting on the opening 2 to resting on the rolling mechanisms 3. For other shapes that involve sides of various lengths, such as rectangles or cylinders, it is preferred, when possible given the nature of the item to be transported, that the opening 2 be shorter in length in relation to the rolling mechanisms 3 upon which the container 1 will be shifted. This will facilitate an easier shift from the opening 2 facing down position to rolling mechanisms 3 facing down position (i.e., shifting off of a shorter side and onto a longer side is easier). This arrangement would also provide a more stable base for movement during transport because it would provide a larger rolling base area. (The rolling base 5 is described further below). However, other design restraints may dictate a variety of arrangements and those skilled in the art will recognize that the selection of the placement of the opening 2 and the rolling mechanisms 3 can vary depending upon the shape of the container 1, the item to be transported, and the location of other features of the container, all within the scope of this invention.

In the disclosed embodiments, the container 1 is constructed of nylon. Nylon is used to provide a durable container that is also light and flexible. A flexible container as shown in FIG. 2 has the advantage of being collapsible to facilitate storage and easier handling of the container 1. The embodiment of FIG. 2 is shown in a partially collapsed state in the top right figure of STEP 2.

The container 1 depicted in FIG. 2 uses a padded nylon construction well known in the art to provide a transport container that is durable and protective, yet also light and collapsible for ease of handling. Specifically, the sides of the container 4a-4e (not labeled on FIG. 2 but labeled on FIG. 1) that form the storage compartment 4 are fabricated with two layers of nylon, an interior layer 6 and an exterior layer 7, separated by 5 mm polyurethane padding. (The padding is not visible in the drawings because it is stitched between the nylon layers. The interior and exterior nylon layers are labeled on the lower figure of FIG. 2, STEP 2). The interior nylon layer 6, which forms the interior of the storage compartment 4 depicted in FIG. 2, is a type well known in the art as 420D nylon. The exterior nylon layer 7, which forms the exterior of the storage compartment 4 depicted in FIG. 2, is a type well known in the art as 1200D nylon. Stitching, also well known in the art of fabrication of bags and carrying cases, is used to secure the padding (not shown) and nylon layers together to construct the storage compartment 4.

Though padded nylon is a desirable material for constructing the storage compartment 4, the invention can also be practiced with a variety of materials. Other suitable flexible materials, such as canvas and leather, among others, can be utilized. Padding may be used but is not a necessary element of the invention. In addition, the invention can also be practiced with a rigid storage compartment 4 made of any suitable material such as wood, plastic, and metal, among others. Thus, the invention is not limited to any particular type of material, and the container 1 need not be secured together by stitching. Any suitable method of transport container construction can be utilized to practice the invention. However, for ease of handling and storage, a collapsible and non rigid container is included in the preferred embodiments.

The rolling mechanisms 3 of the disclosed embodiments are castered wheels well known in the art of rolling transport containers. The depicted embodiments utilize four wheels 3a-3d attached to the exterior of the container 1 in a substantially equidistant arrangement about the side (4e in FIG. 1) of the storage compartment 4 upon which the container 1 will roll during transport (hereinafter the rolling base 5). The four attached wheels 3a-3d attached to the side 4e form a rolling base 5 for the loaded container. The invention can be practiced with any suitable number and type of rolling mechanisms that can be attached to the rolling base 5.

In the disclosed embodiments, a 5 mm thick wooden board 9 is sewn in between the interior 6 and exterior 7 nylon layers of the rolling base 5 to provide a more rigid surface for attachment of the rolling mechanisms 3. The board 9 is hidden between the nylon layers 6&7 and thus not visible in the drawings. The board 9 is shaped in accordance with the desired arrangement of the rolling mechanisms 3 as well as the size and shape of the rolling base 5, and placed within the nylon layers 6&7 at the location the rolling mechanisms 3 are to be attached (side 4e in FIG. 1). Thus, the board 9 becomes part of the rolling base 5. In the embodiments of FIG. 2, the board 9 (not labeled in FIG. 2) is rectangular and sized to correspond with the rolling base 5 and to fit within the nylon layers of the rolling base 5. The dimensions of the board utilized in the FIG. 2 embodiments are 23.5×22.5 inches. The edges of the board 9 can be rounded to prevent it from damaging the nylon 6&7 that surrounds it. The board 9 is placed between the interior 6 and exterior 7 layers of nylon, adjacent to the polyurethane padding such that the padding is adjacent to the interior nylon 6, and the board 9 is adjacent to the exterior nylon 7.

The board 9 can be secured between the nylon layers 6&7 with stitching and/or adhesives. It is further secured in place by attachment of the rolling mechanisms 3. This manner of using a board 9 to form a more durable surface for attachment of rolling mechanisms 3 and to provide a more rigid rolling base 5 in a soft sided transport container is well known in the art. It will be understood by those skilled in the art that materials other than wood, such as plastic for example, can be used for the board 9, and that any suitable method of securing the board to the container can be utilized within the scope of the invention. The board 9 may also comprise multiple pieces as opposed to a single piece, all such variations being within the scope of the invention.

The invention may be practiced without the board 9. However, for soft sided or collapsible embodiments, the board 9 is recommended to provide more durable attachment of rolling mechanisms 3, and to provide a sturdier rolling base 5 for the container 1.

The rolling mechanisms 3 are attached to the rolling base 5 in any manner appropriate for the type of rolling mechanisms 3 used and the material selected for the rolling base 5. In the disclosed embodiments, the castered wheels 3 are a metal type commonly used in the art for rolling transport containers. They are available pre-mounted on caster plates 8, as depicted in FIG. 1, and the caster plates 8 can be readily bolted or riveted to the rolling base 5. In the disclosed embodiments, a polyethylene plastic sheet material (3mm thick) 27 is utilized between the caster plates 8 and the exterior nylon 7 to protect the nylon from the metal caster plates 8. This sheeting 27 can be attached to the nylon by stitching, adhesives, bolting, riveting, or any other suitable manner. In the embodiment of FIG. 1, the sheeting 27 is stitched onto the nylon. Reinforcing nylon strips 10 can be utilized to further enhance the durability of the attachment, as depicted in FIG. 1. The strips 10 are stitched to the exterior nylon in FIG. 1.

The caster plates 8 of the FIG. 1 embodiment are bolted or riveted through the sheeting 27, and through the reinforcing nylon strips 10, and through the exterior nylon layer 7 to the board 9 such that the caster plates 8 are securely attached to the rolling base 5 at the locations selected for the placement of the wheels 3. The exterior nylon layer 7 is captured between the board 9 and the caster plates 8. Any suitable method of durably attaching the rolling mechanisms 3 to the rolling base 5 can be utilized within the scope of the invention.

The container 1 of the disclosed embodiments includes a closing mechanism 11 in the form of a zip down flap 11. The flap 11 is constructed of padded nylon in the same fashion as described above for the sides (4a-4e) of the storage compartment 4. The outer edge of the flap 11 is fitted with a zipper 12, and the corresponding edge of the opening has a mating zipper 13 around it for securing the flap 11 to the opening 2 to close the container 1. FIG. 1 depicts an embodiment in which the flap 11 has 3 free edges 14, 15, 16, and a fourth edge that is permanently connected to the container 17. In the preferred embodiment, the fastening element 12 is only provided on the two sides (14 and 16) of the flap 11 that extend from the edge that is permanently connected 17, but not on the side labeled 15. Zip down flap closing mechanisms, as well as a variety of other closing mechanisms, are well known in the art of transport containers. It should be appreciated that other closing mechanism arrangements could be used without departing from the invention as claimed herein.

The depicted embodiments include Velcro tabs 20 affixed to the edges of the flap 11. These tabs 20 are positioned to line up with mating Velcro tabs 20 on the exterior surface of side 4b of the storage compartment (not visible in FIG. 1). These mating Velcro tabs 20 allow the zip down flap 11 to be secured to side 4b (as depicted in FIG. 1) and out of the way of the opening 2 during the loading process. (The loading process is described in detail below). The invention can be practiced without the Velcro tabs 20.

FIG. 1 depicts an embodiment that includes two skid bars 18 on the exterior of side 4b. Skid bars are useful to provide a non-rolling surface upon which to slide the loaded container, as for example, to slide the container about in the back of a truck or van. The skid bars 18 can be fabricated from polypropylene plastic, or any other suitable material. The depicted skid bars 18 are a sloping elongated shape, and they are externally riveted to the side of the container 1. In FIG. 1, they are riveted to a side 4c of the container that is adjacent to the rolling base 5 so that the container can be readily shifted from the rolling mechanisms 3 to the skid bars 18 when desired. In the disclosed embodiment, a shift from the rolling mechanisms 3 to the skid bars 18 would be approximately ninety degrees. Polyethylene plastic sheeting can be secured (by stitching, adhesives, riveting, etc.) in between the external nylon 7 and the padding at the location where the skid bars 18 are to be riveted to provide a more durable riveted connection and to provide a more rigid surface upon which to slide the container 1 about when using the skid bars 18. It should be appreciated that the invention can be practiced without skid bars, or with any variety of skid bar arrangements or other devices which provide for a durable connection between the skid bars and the container as are known and desired by those skilled in the art.

The rolling transport container 1 can be further equipped with a variety of handles and pockets. A useful arrangement is as depicted in FIG. 1. The tow handle 19 is an adjustable, removable nylon strap 19 secured with rivets 22a, and reinforced with rivets 22b and 22c (rivets hereinafter collectively 22). The tow handle 19 is riveted at each end 22a to the external sides of the container 1 as shown in FIG. 1. A quick release clasp and buckle arrangement 21 allows for removal of the tow handle 19. The tow handle 19 is rivet reinforced along a diagonal nylon reinforcement strip 22 to distribute the towing weight from the rivet 22a nearest the quick release clasp 21 to the various reinforcement points 22b&c along the sides of the container in accordance with the angle of the tow handle 19. The tow handle 19 can have an adjustment means, such as a buckle adjustment means (not depicted) if desired.

Loading handles 23 are attached in a reinforced manner on side 4c in FIG. 1 (the side opposite the opening 2) to facilitate lowering and raising the container 1 onto and off of the item to be loaded and transported. Additional handles can be provided, such as the lift handles 24 that are visible on side 4a of the container 1. Corresponding lift handles (not visible) can be attached to the exterior of side 4d. The lift handles 24 are useful for lifting the loaded container 1, such as into a transport truck or van. The loading and lifting handles can be nylon strap handles that are riveted in a weight distributing manner as described above for the tow handle 19 and as depicted in FIG. 1. Comfort grips of rubber, leather, or other suitable material, such as the depicted tow handle grip 25 can be utilized as desired. It will be appreciated that many varieties and arrangements of handles can be utilized within the scope of the invention, and that the invention is not limited to any particular handle arrangements, so long as they do not interfere with the shifting of the container 1 onto and off of the rolling mechanisms 3. Handles are not necessary to practice the invention.

Pockets can be added as desired as well, so long as they do not prevent the shifting of the container 1 onto and off of the rolling mechanisms 3. Pockets can be fashioned in any suitable manner known in the art. The disclosed embodiments include two external nylon pockets 26 on sides 4a (visible in FIG.1) and 4d (not visible).

In the disclosed embodiments, the rolling mechanisms that become the front rollers during towing (3a and 3b) swivel, while the rolling mechanisms that become the back rollers during towing (3c and 3d) do not swivel. This arrangement allows for better control and turning of the container 1 while it is being pulled or pushed on its rolling base 5, though it is not necessary to practice the invention.

Modifications and variations of the present invention that would be obvious to a person of ordinary skill in the art are deemed to be within the scope of the present invention.

Methods for using the rolling transport container of the present invention will now be described with reference to the attached drawings. FIG. 2 depicts preferred methods for using the rolling transport container of the present invention to transport a pro audio speaker that is approximately 22 in.×24 in.×25 in. and weighs approximately 75 lbs. This pro audio speaker is depicted in STEP 1 of FIG. 2.

The figures of STEP 2-STEP 6 depict a rolling transport container 1 in accordance with the present invention that can be used to transport the pro audio speaker depicted in STEP 1. The depicted transport container 1 is collapsible and made of padded nylon as described in detail above. It is 26×25×26 inches and weighs approximately 13 lbs. These dimensions are useful for transporting the speaker depicted in STEP 1 of FIG. 2, but those skilled in the art will recognize that a variety of shapes and dimensions may be utilized within the scope of the invention.

In the STEP 2 figures, the container 1 is shown resting on its wheels 3 (not visible) with the opening 2 facing out. The top left figure depicts the container 1 with the zip down flap 11 in the zipped and closed configuration, and the user just beginning to unzip the mated zipper 12,13 to open the flap 11 and expose the opening 2 of the container 1. The user is holding the container 1 up from its collapsed state. The top right figure shows the container 1 with the zip down flap 11 completely unzipped and the user now securing the flap 11 away from the opening 2 via the Velcro tabs 20 discussed above. The bottom figure of STEP 2 shows the container 1 with the flap 11 secured out of the way of the opening 2, and the container 1 ready to be lowered over the speaker. The storage compartment 4 is visible in this figure.

STEP 3 shows the user utilizing the load handles 23 described above to hold the container 1 in an “opening 2 down” orientation. In this orientation the container 1 can be lowered over the speaker and thus load the speaker into the storage compartment 4. The user has oriented the rolling mechanisms 3 (3a, 3b, 3c visible) to the left side of the speaker and away from the front of the speaker (from the perspective of looking into the figure) so that when the loaded container 1 is shifted onto the rolling mechanisms 3 (STEP 4), the delicate front of the speaker will not be on the bottom and will not be bearing the weight of the load.

STEP 4 shows the container 1 completely lowered over the speaker. The speaker is now contained within the storage compartment 4 (no longer visible), and the user is shifting the container 1 from the “opening 2 down” orientation to the “wheels 3 down” orientation.

STEP 5 shows the loaded container 1 resting on the wheels 3 (only 3d visible). In the top left figure, the user is pushing on the exposed speaker at the opening 2 to ensure that the speaker is completely within the storage compartment 4. In the top right figure, the user is releasing the zip down flap 11 by disconnecting the Velcro tabs 20. In the bottom figure, the user is closing the zipper (12,13) to secure flap 11 over the opening 2.

STEP 6 shows the user transporting the speaker on the rolling mechanisms 3 (3a and 3d visible) by pulling the tow handle 19.

Variations in the method of use of the present invention will be obvious to those skilled in the art. The method is not limited to speakers, but to a large variety of items that need to be easily transported. The user need not make use of a closing mechanism or Velcro tabs. There are a variety of ways to hold the container during use, and a variety of ways to orient the container when lowering it over an item. Thus, the invention is not limited to the exact method of use as depicted in FIG. 2. Rather, FIG. 2 is provided to ensure a complete disclosure of the method, including the preferred steps.

What is claimed is:

1. A rolling container for transporting items comprising:
a storage compartment having an opening and one or more rolling mechanisms;
said opening large enough to be lowered over the item to be transported;
said storage compartment large enough to contain the item to be transported;
said rolling mechanisms attached to the exterior of the storage compartment at a location adjacent to said opening such that after the item to be transported is enclosed within said storage compartment, the container can be shifted approximately ninety degrees from a position of resting on the item to be transported (opening down) to a position of resting on said rolling mechanisms (rolling mechanisms down).

2. A rolling container as set forth in claim 1, wherein said storage compartment and said opening are made of a material that is flexible and light such that the container is collapsible.

3. A rolling container as set forth in claim 1, wherein said storage compartment further comprises a board, said board providing a structure for which to attach said rolling mechanisms.

4. A rolling container as set forth in claim 1, wherein said rolling mechanisms are wheels.

5. A rolling container as set forth in claim 1, wherein said opening is equipped with a closing mechanism.

6. A rolling container as set forth in claim 5, wherein said closing mechanism is a zippered flap.

7. A rolling container as set forth in claim 1, further comprising one or more loading handles.

8. A rolling container as set forth in claim 7, wherein said loading handles are situated opposite to said opening.

9. A rolling container as set forth in claim 1, further comprising one or more skid bars.

10. A rolling container as set forth in claim 9, wherein said skid bars are situated opposite said opening.

11. A rolling container as set forth in claim 1, further comprising a tow handle.

12. A rolling container for transporting items comprising:
a storage compartment having an opening and one or more rolling mechanisms;
said opening large enough to lower over the item to be transported;
said storage compartment large enough to contain the item to be transported;
said storage compartment fabricated of a material that is soft enough to allow said storage compartment to collapse when empty;
one or more rolling mechanisms attached to the exterior of said storage compartment;
said storage compartment further comprising a base, said base providing a structure for which to attach said rolling mechanisms;
said rolling mechanisms located in relation to said opening such that after the item to be transported is received into said storage compartment, the container can be shifted approximately ninety degrees from a position of resting on the item to be transported (opening down) to a position of resting on said rolling mechanisms (wheels down).

13. A rolling container as set forth in claim 12, wherein said rolling mechanisms comprise two front swiveling casters and two rear non-swiveling casters.

14. A rolling container as set forth in claim 12, wherein said opening is equipped with a closing mechanism.

15. A rolling container as set forth in claim 12, further comprising one or more skid bars.

16. A rolling container as set forth in claim 15, wherein said skid bars are situated opposite said opening.

17. A rolling container as set forth in claim 12, further comprising a tow handle.

18. A rolling container as set forth in claim 12, further comprising one or more external pockets.

19. A method for loading an item to be transported into a rolling transport container comprising the following steps:
lowering the opening of the container over the item to be transported until the item is substantially contained within the storage compartment;
shifting the loaded container approximately ninety degrees until the item to be transported is resting on the rolling mechanisms.
